(19) United States
(12) Patent Application Publication
(10) Pub. No.: US 2024/0383698 A1
(43) Pub. Date: Nov. 21, 2024

(54) Suction device multipick detection

(71) Applicant: RightHand Robotics, Inc., Charlestown, MA (US)

(72) Inventor: Eric Storm, Arlington, MA (US)

(21) Appl. No.: 18/647,886

(22) Filed: Apr. 26, 2024

Related U.S. Application Data
(60) Provisional application No. 63/467,530, filed on May 18, 2023.

(51) Int. Cl. B65G 47/91

(52) U.S. Cl. CPC B65G 47/917; B65G 47/91

(57) ABSTRACT

Suction cup devices and apparatus for performing a picking operation. The robotic picking device includes a suction device, a vacuum device in operable connectivity with the suction device and configured to generate a suction force to enable the suction device to perform a grasp attempt, at least one pressure sensor operably positioned with respect to the suction device and the vacuum device, and configured to detect a pressure level associated with the suction device at least during the grasp attempt, and a control system configured to analyze the detected pressure level to determine whether the suction device grasped more than one item during the grasp attempt.

### CROSS-REFERENCE TO RELATED APPLICATIONS

The present application claims the benefit of and priority to co-pending U.S. provisional application No. 63/467,530, filed on May 18, 2023, the entire disclosure of which is incorporated by reference as if set forth in its entirety herein.

### TECHNICAL FIELD

Embodiments described herein generally relate to robotic devices and methods and, more particularly but not exclusively, to robotic devices and methods for grasping items.

### BACKGROUND

Logistic operations such as those in warehouse environments often include robotic devices to gather items from a first location (e.g., a container) and place the items at a second location (e.g., on a conveyor belt). Accordingly, these operations require the robotic device to first grasp the item. Existing robotic devices often include a suction device that generates a suction force to “grasp” the item.

Robotic devices are often figured with one or more suction devices (e.g., suction cups) to generate a suction force to grasp an item. A suction device may perform a picking operation by creating a seal between the suction device and the item, and drawing air out of a volume between the suction device and the item such that a portion of the item is exposed to low pressure. This allows external air pressure to push the item in the direction of the suction device.

The quality of a grasp between a suction device and an item is dependent on creating a quality seal and maximizing the surface area of the item that is inside the seal. Existing techniques for improving seal quality involve conforming the suction device to the item by using flexible lips, foam pads, or the like.

During a grasp attempt, however, a single suction device may inadvertently pick up or otherwise grasp more than one item. This is referred to as a “multipick.” Multipicks can result in the incorrect number of items being transferred from a pick location to a place location. Alternatively, multipicks can cause the suction device to drop the items during transfer due to a weak seal.

A need exists, therefore, for suction cup devices that overcome the disadvantages of existing devices.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a robotic picking device. The robotic picking device includes a suction device; a vacuum device in operable connectivity with the suction device and configured to generate a suction force to enable the suction device to perform a grasp attempt; at least one pressure sensor operably positioned with respect to the suction device and the vacuum device, and configured to detect a pressure level associated with the suction device at least during the grasp attempt; and a control system configured to analyze the detected pressure level to determine whether the suction device grasped more than one item during the grasp attempt.

In some embodiments, the control system is further configured to perform a corrective action upon determining the suction device grasped more than one item during the grasp attempt. In some embodiments, the corrective action includes at least one of issuing an alert or releasing the items.

In some embodiments, the control system is further configured to obtain a first input pressure level from the pressure sensor before the suction device performs the grasp attempt; compare the first input pressure level to an expected input pressure level, and issuing an alert upon detecting that the first input pressure level deviates from the expected input pressure level beyond a threshold amount.

In some embodiments, the control system determines that the suction device grasped more than one item based on the pressure level detected during the grasp attempt being above a threshold pressure level.

In some embodiments, the robotic picking device further includes a mass detection device configured to detect a mass of at least one item grasped by the suction device, wherein the control system further determines that the suction device grasped more than one item during the grasp attempt based at least in part on the detected mass. In some embodiments, the robotic picking device further includes an arm portion operably connected to the suction device, wherein the mass detection device is configured with the arm portion.

In some embodiments, wherein the suction device is further configured to perform a second grasp attempt upon the control system determining the suction device grasped more than one item during the grasp attempt.

In some embodiments, the at least one pressure sensor includes a vacuum pressure sensor positioned to measure a vacuum pressure level associated with the suction device. In some embodiments, the control system determines the suction device grasped more than one item based on a difference between a vacuum pressure level before the grasp attempt and a vacuum pressure level during the grasp attempt being above a threshold amount.

According to another aspect, embodiments relate to a method of performing a grasp attempt. The method includes positioning a suction device to perform a grasp attempt; generating, using a vacuum device in operable connectivity with the suction device, a suction force to enable the suction device to perform a grasp attempt; detecting a pressure level associated with the suction device at least during the grasp attempt using at least one pressure sensor; and analyzing, using a control system, the detected pressure level to determine whether the suction device grasped more than one item during the grasp attempt.

In some embodiments, the method further includes performing a corrective action upon the control system determining the suction device grasped more than one item. In some embodiments, the corrective action includes at least one of issuing an alert or releasing the items.

In some embodiments, the control system determines whether the suction device grasped more than one item during the grasp attempt by obtaining a first vacuum pressure level from the at least one pressure sensor before the suction device performs the grasp attempt, comparing the first vacuum pressure level to an expected input pressure level, and issuing an alert upon detecting that the first vacuum pressure level deviates from the expected input pressure level beyond a threshold.

In some embodiments, the control system determines that the suction device grasped more than one item based on the pressure level detected during the grasp attempt being above a threshold pressure level.

In some embodiments, the method further includes detecting, using a mass detection device, a mass of the at least one item grasped by the suction device, wherein the control system determines that the suction device grasped more than one item during the grasp attempt based at least in part on the detected mass. In some embodiments, the suction device is positioned via an arm portion operably connected to the suction device, and the mass detection device is configured with the arm portion.

In some embodiments, the method further includes performing a second grasp attempt upon determining the suction device grasped more than one item during the grasp attempt.

In some embodiments, detecting the pressure level associated with the suction device at least during the grasp attempt includes measuring a vacuum pressure level from the suction device using a vacuum pressure sensor. In some embodiments, the control system determines the suction device grasped more than one item based on a difference between a vacuum pressure level before the grasp attempt and a vacuum pressure level during the grasp attempt being below a threshold amount.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates an exemplary warehouse environment in accordance with one embodiment;

FIGS. 2A-C illustrate a robotic picking device performing a single pick grasp;

FIGS. 3A-C illustrate a robotic picking device performing a multipick grasp;

FIG. 4 illustrates a diagram of a robotic picking device in accordance with one embodiment; and

FIG. 5 depicts a flowchart of a method of performing a grasp attempt in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

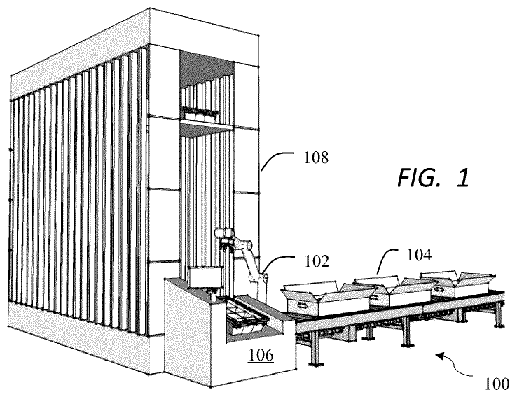

FIG. 1 illustrates an exemplary application in a warehouse environment 100 in which a robotic picking device 102 may be tasked with picking items from one or more containers 104, and placing the items at a loading station 106. These items may then be placed in a shipping container 108 for further shipment, sorting, processing, or the like

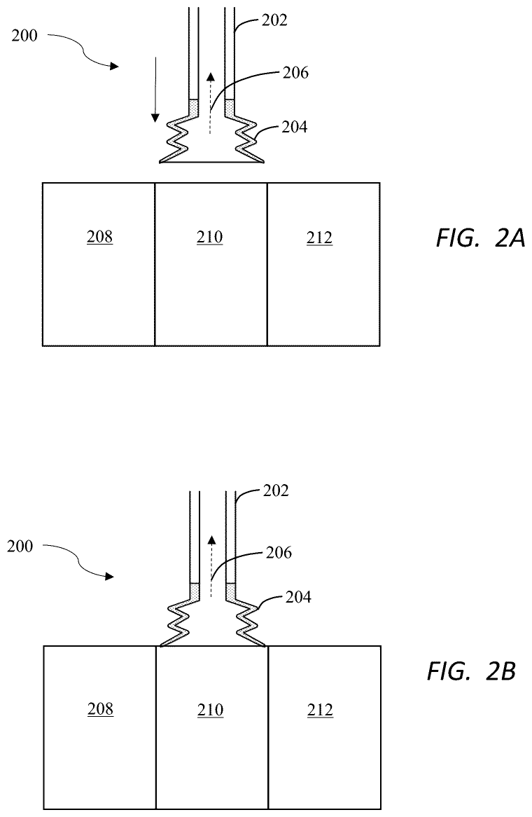

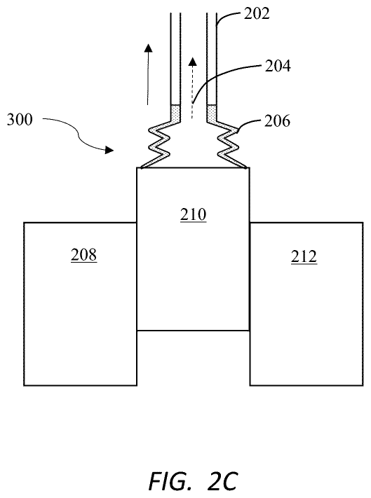

FIGS. 2A-C illustrate a portion of a robotic picking device 200 performing a single pick grasp. The picking device 200 may include an arm 202 with a suction device 204 configured thereon. The suction device 204 may be in operable connectivity with a vacuum force generator (not shown in FIGS. 2A-C) to generate a suction force 206. The robotic picking device 200 may be tasked with performing a picking operation with respect to one of items 208, 210, or 212.

FIG. 2A illustrates the picking device 200 moving toward item 210. In this case, the picking device 200 may be tasked with removing the item 210 from its location in FIG. 2A, transferring the item 210 to a place location, and then releasing the item 210 at the place location.

FIG. 2B illustrates the suction device 204 in contact with the item 210 during a grasp attempt. At this point, the suction device 204 has moved toward and contacted the item 210 such that the suction force 206 creates a seal between the suction device 204 and the item 210. This exposes a portion of the item 210 to low pressure and, as seen in FIG. 2C, enables the picking to pick up the item 210 for transfer.

FIGS. 2A-C illustrate process of a successful single pick. That is, the robotic picking device 200 intended to grasp only item 210 and was able to grasp and transfer only item 210.

As discussed previously, however, existing picking devices that use suction devices for grasping may inadvertently grasp more than one item. For example, items at a picking location may be close to each other such that a suction device has difficulty grasping only a single item. Similarly, thin items such as those on the order of millimeters such as gift cards, stickers, sheets, tissue paper, greeting cards, etc., or items with a hang tabs may be placed on top each other such that a suction device grasps more than one item.

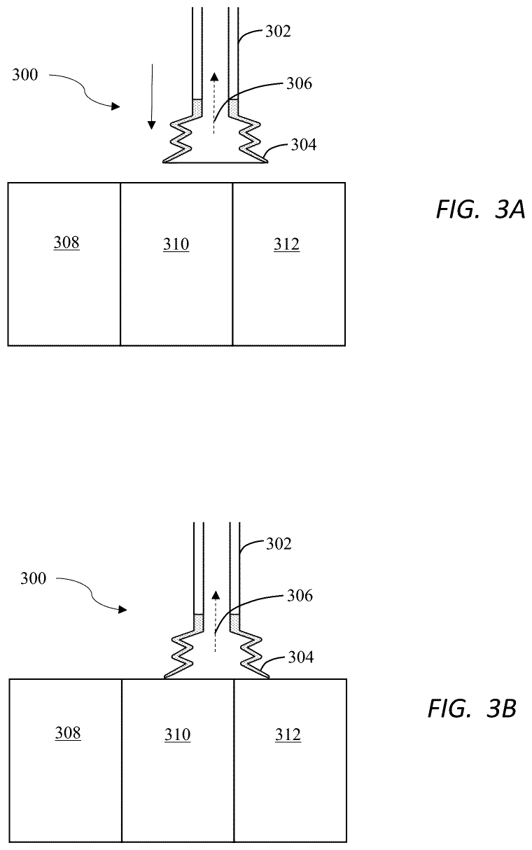

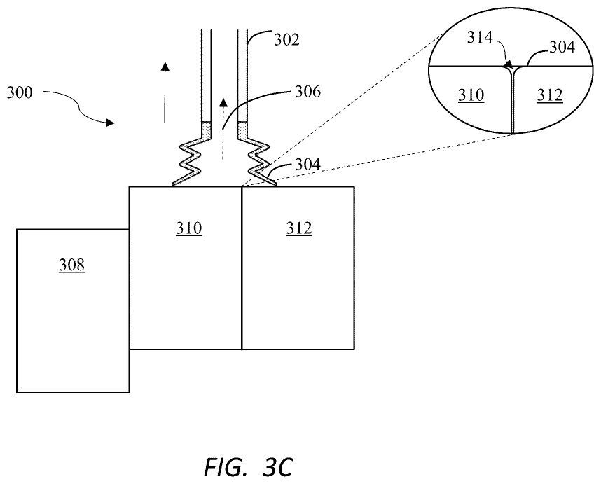

FIGS. 3A-C illustrate a portion of a robotic picking device 300 performing a multipick. The picking device 300 may include an arm 302 with a suction device 304 configured thereon. The suction device 304 may be in operable connectivity with a vacuum force generator (not shown in FIGS. 3A-C) to generate a suction force 306. The robotic picking device 300 may be tasked with performing a picking operation respect to one of items 308, 310, or 312.

For example, FIG. 3A illustrates the picking device 300 moving toward items 310 and 312. However, the picking device 300 may intend to or be instructed to grasp only item 310. If items 310 and 312 are close together as in FIGS. 3A-C, it may be difficult for the picking device 300 to grasp only the item 310. This is particularly true if the diameter of the suction device 304 is the same or only slightly smaller than the width of the grasping surface of the item 310. In this case, it may be likely that a portion of the suction device 304 extends over the edge of item 310 and onto item 312.

FIG. 3B illustrates this scenario and shows the suction device 304 in contact with items 310 and 312. At this point, the suction device 304 has moved toward and contacted both items 310 and 312 such that the suction force 306 creates at least a partial seal between the suction device 304 and items 310 and 312. This exposes a portion of each of items 310 and 312 to low pressure and, as seen in FIG. 3C, the picking device 300 picks both items 310 and 312.

There will likely be a gap 314, albeit minor, between items 310 and 312. The resultant seal is therefore weaker than it would be if there were no gap (e.g., if the suction device grasped only item 310).

This may cause the suction device 304 to inadvertently drop items 310 and 312 during transfer. This may damage the items, or may require a human operator to intervene (e.g., to pick up the dropped items and complete the task). Even if the suction device 304 places both items 310 and 312 at the place location, the multipick may cause inaccurate inventory lists. For example, a logistics management system tracking the location of items or number of items at a given location may be unaware that the robotic picking device grasped and moved item 312. Accordingly, the logistics management system may incorrectly believe that item 312 is at a particular location. Similarly, this may lead to a customer receiving more than what they ordered.

The described embodiments provide novel techniques for detecting and preventing multipicks. The embodiments herein rely on one or more pressure sensors that are in operable connectivity with a suction device to detect multipicks.

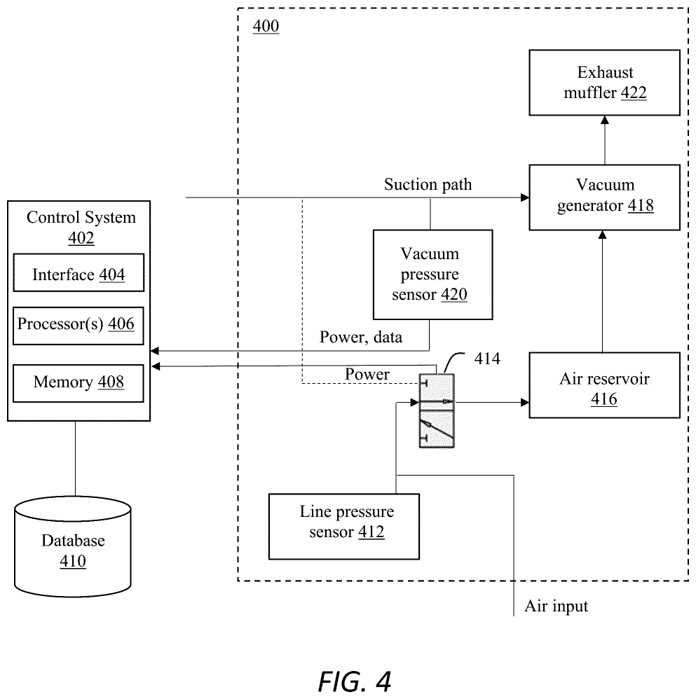

FIG. 4 illustrates a diagram of a robotic picking device 400 in accordance with one embodiment. The robotic picking device 400 may also include or otherwise be in communication with a control system 402 that includes an interface 404, and one or more processors 406 executing instructions stored on memory 408. The control system 402 may also be in communication with one or more databases 410.

The processor(s) 406 may be any hardware device capable of executing instructions stored on memory 808 to provide various components or modules. The processor 806 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 806 may be configured as part of the robotic picking device 400 or located at some remote location.

The memory 408 may be L1, L2, L3 cache, or RAM memory configurations. The memory 808 may include non-volatile memory such as flash memory, EPROM, EEPROM, ROM, and PROM, or volatile memory such as static or dynamic RAM, as discussed above. The exact configuration/type of memory 808 may of course vary as long as instructions for performing grasp attempts and analyzing results of the grasp attempts can be performed.

The robotic picking device 400 may include a line pressure sensor 412, one or more valves 414, an air reservoir 416, a vacuum generator 418, a vacuum pressure sensor 420, and an exhaust muffler 422. Certain components such as the line pressure sensor 412 and vacuum pressure sensor 420 may be configured on, with, or otherwise in operable connectivity with a printed circuit board (PCB), not shown. One or more of these components may be configured with or otherwise onboard with the robotic picking device.

The line pressure sensor 412 may be optional and may be in operable communication with the control system 402 to receive power from and communicate data therewith. The line pressure sensor 412 may pressure associated with a compressed air supply circuit in connectivity with the robotic picking device 400. This pressure is unlikely to change over a short period of time, but changes therein may be due to how many devices are connected to the supply circuit, how much power a connected device is using, etc. This pressure may also change due to manual adjustment of input valves and regulators, wherein such adjustment may be intentional or accidental.

Accordingly, the embodiments herein may monitor the input line pressure and how it compares to expected input line pressure. If the input line pressure deviates from what is expected by more than a threshold amount, the embodiments herein may issue an alert to an operator, disable the robotic picking device, or the like.

The control system 402 may operate the valve 414 which, as seen in FIG. 4, may be a 3 way/2 position valve. The first position is shown in FIG. 4, in which an air input may flow through the valve 414 to the air reservoir 416. The second position blocks air from the compressed air inlet and allows the air reservoir 416 to vent.

In operation, compressed air may pass through the air input channel and the valve 414 at high pressure. The air may be directed from the reservoir 416 to the vacuum generator 418 to draw in air through the suction device.

The vacuum generator 418 may include a Venturi device in operable connectivity with the reservoir 416. The vacuum generator 418 may also be in operable connectivity with an air line that extends through a suction device (not shown in FIG. 4). It is noted that the vacuum generator 418 may generate an undesirable amount of noise. The embodiment shown in FIG. 4 may further include an exhaust muffler 422 and/or a sound absorbing material to reduce the amount of noise.

The robotic picking device 400 may be configured with a predetermined vacuum pressure level. For example, if the robotic picking device 400 routinely performs picking operations with respect to a certain item, the vacuum generator 418 may produce a suction force that is optimized for that item (e.g., high enough to grasp the item, but not high enough to damage the item).

These optimized pressure levels may be stored in the databases 410. These pressure levels may be determined empirically through experimentation, for example. The database 410 may store data regarding, for a particular item, the measured pressure level in an “unpicked” state (i.e., there are no items grasped by the suction device), the vacuum pressure level associated with a single pick of a particular item, and the vacuum pressure level associated with a multipack of particular items.

The vacuum pressure sensor 420 may measure the pressure in the vacuum line and communicate data regarding the measured pressure to the control system 402. As discussed previously, this pressure level may indicate whether the robotic picking device grasped a single item or multiple items.

Before a grasp attempt, an operating pressure detected by the vacuum pressure sensor 420 may be 4/5 atm or approximately 810 Millibar [mbar]. This initial operating pressure may be based on the size of the vacuum generator, among other factors.

This pressure will drop during a grasp attempt. More specifically, once the suction device has moved close to the item such that a portion of the item is exposed to low pressure in the suction device and remains in contact, the vacuum pressure sensor 420 will detect a pressure that is lower than the initial operating pressure.

A successful pick attempt (i.e., a pick attempt that grasps only a single item) may cause the vacuum line pressure to decrease by approximately 50-60%. For example, with the initial vacuum pressure described above of 810 mbar, a single pick may cause the vacuum pressure level to decrease to 350-400 mbar.

A multipick, on the other hand, may cause the vacuum pressure to decrease but not by as much as a single pick. For example, with the initial vacuum pressure described above of 810 mbar, a multipick may cause the vacuum pressure level to only decrease to 600 mbar (e.g., by approximately 25%).

These changes in pressure values are exemplary, and the vacuum pressure may change more than or less than the above values. The amount of pressure may vary and may depend on factors such as the type of suction cup material, suction cup size, item type (e.g., cardboard vs. polybag, porous, vs. non-porous, etc.), input pressure, or the like.

A user may define thresholds for classifying picks based an amount of pressure change. These thresholds may be based on numerical values associated with pressure. For example, a user may require a pressure change of 400 mbar in order for a pick to be classified as a single pick. In this case, a grasp attempt that produces a pressure change that is less than 400 mbar would be classified as a multipick.

A user may also specify these thresholds in terms of percentages. For example, a user may require a pressure change of at least 45% in order for a pick to be classified as a single pick. In this case, a grasp attempt that produces a pressure change that is less than 45% would be classified as a multipick.

The amount of pressure change detected by the vacuum pressure sensor 420 may be a function of the input line pressure. For example, if the input pressure is low, the change in vacuum pressure—resulting from single picks and multipicks—may also be low. If the input pressure is high, the change in vacuum pressure resulting from single picks and multipicks may be high. Accordingly, the vacuum pressure change may be scaled by some factor to account for the input pressure and its effect on vacuum pressure changes.

In some embodiments, the vacuum pressure sensor 420 may measure ambient or atmospheric pressure. The vacuum pressure sensor may gather this data when the vacuum generator 418 is not active. This may be helpful in compensating for elevation of the robotic picking device 400.

In some embodiments, the robotic picking device 400 may also monitor the weights of any item(s) picked. For example, the control system 402 or robotic arm may further include a weight scale or load cell for detecting the weight of any item(s) picked.

The database 410 may store data regarding various items such as their weights. Accordingly, the processor(s) 406 may know the expected weight of an item to be picked. If a certain item has a known weight W, and a pick attempt produces a weight of 2 W, 3 W, etc., the processor may determine that the grasp attempted resulted a multipick. This may provide an additional level of confidence of whether the robotic picking device 400 performed a single pick or a multipick.

Additionally or alternatively, the embodiments described herein may implement or otherwise also rely on imagery-based techniques. In these embodiments, one or more imagery gathering devices may gather imagery of a robotic picking device 400, its environment, item(s) in the environment, etc. Computer vision software may analyze imagery from these imagery gathering devices to help determine whether the robotic picking device performed a single pick or a multipick. However, the described embodiments do not require the use of imagery gathering devices, computer vision software, etc.

Upon detecting a multipack, the control system 402 may initiate one or more corrective remedial actions. In some embodiments, a corrective action may involve the robotic picking device 400 returning the item(s) to the location from which they were picked (e.g., a tote, bin, container, conveyor belt, etc.). The control system 402 may instruct the robotic picking device to maneuver the suction device to be in proximity to the pick location, and the control system 402 may turn off the vacuum generator 418, change the position of the valve 414 to turn off the suction source, etc. The robotic picking device 400 may then reattempt the picking operation. This process may be repeated until the robotic picking device 400 performs a single pick.

As another example of a corrective action, the control system 402 may instruct the robotic picking device 400 to deposit the item(s) in a designated location. The control system 402 may log the incident for further review and analysis. For example, the control system 402 may create an entry in the database 410 regarding the multipick. Additionally or alternatively, the control system 402 may communicate an alert to personnel to inspect the incident.

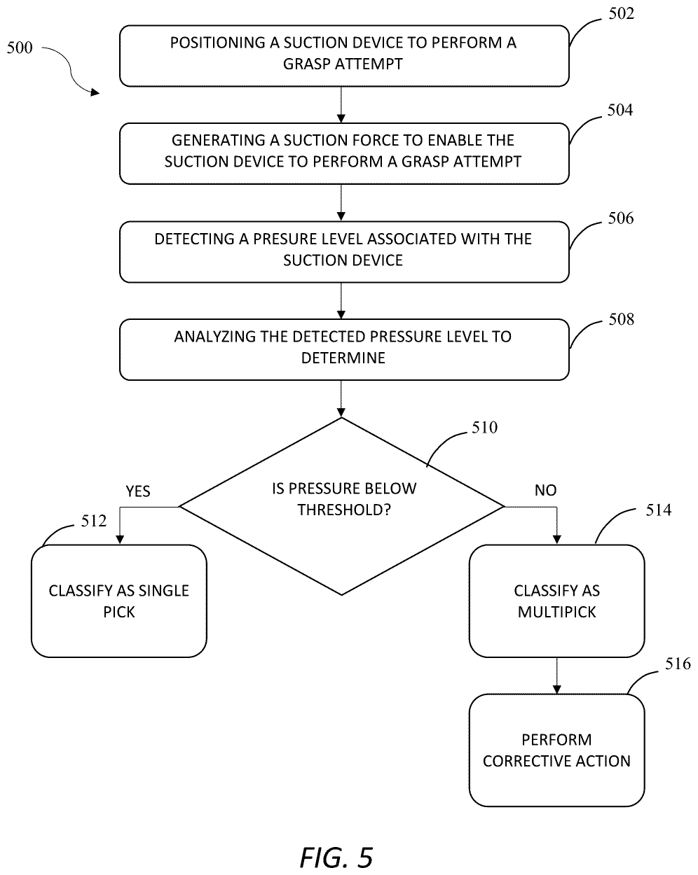

FIG. 5 depicts a flowchart of a method 500 of performing a grasp attempt. The robotic device of FIG. 4 or components thereof may perform one or more of the steps of method 500. Step 502 involves positioning a suction device to perform a grasp attempt. The suction device may be connected to or otherwise configured with a robotic picking device such as a robotic arm portion. The robotic picking device may be tasked with performing a picking operation that involves approaching an item, grasping the item, moving the item to a place location, and releasing the item at the place location.

Step 504 involves generating, using a vacuum device in operable connectivity with the suction device, a suction force to enable the suction device to perform a grasp attempt. A vacuum force generator such as the vacuum generator 418 of FIG. 4 may be in operable connectivity with the suction device via one or more suction lines. The area within a suction device, as well as any item(s) in contact with the suction device, is exposed to low pressure such that the item(s) may stay in contact with the suction device.

Step 506 involves detecting a pressure level associated with the suction device at least during the grasp attempt using at least one pressure sensor. In the context of the present application, “during the grasp attempt” may refer to the time or period in which an item is “held” by a suction device due to being exposed to low pressure from the suction device. In accordance with step 506, the detected pressure level refers to the pressure level in a vacuum line while an item or items are being held by the suction device by being exposed to low pressure from the suction device.

The sensor of step 506 may refer to the vacuum pressure sensor 420 of FIG. 4. The vacuum pressure sensor 420 may gather data regarding the vacuum pressure line before the robotic picking device performs a grasp attempt (e.g., before the suction device contacts an item or item(s)), during the grasp attempt, and after the grasp attempt (e.g., after item(s) have been disconnected from the suction device). The vacuum pressure sensor 420 may continuously monitor and communicate data regarding the pressure in a vacuum line and communicate this data to the control system 402.

Step 508 involves analyzing, using a control system, the detected pressure level to determine whether the suction device grasped more than one item during the grasp attempt. As discussed previously, changes in pressure and specifically decreases in pressure may be indicative of grasp attempts. Large decreases in pressure in the vacuum line may be indicative of single picks, whereas smaller decreases in pressure in the vacuum line may be indicative of multipicks.

In some embodiments, a user may require that the change in pressure meet or exceed some threshold before it is classified as a pick event. However, the control system 402 may have instructed the robotic picking device 400 to perform the grasp attempt. In these situations, the control system 402 would expect a decrease in pressure and would therefore not require an instruction regarding minimum pressure level change before classifying an event as a pick.

As discussed previously, the control system 402 may classify a grasp attempt as a single pick in step 512 if the vacuum line pressure decreases by at least some threshold amount. This may suggest that the suction device has created a strong seal on a single item. In this situation, the control system 402 may instruct the robotic picking device to continue with the picking operation, such as to continue moving the item to a place location and releasing the item at the place location.

The control system 402 may classify a grasp attempt as a multipick if the vacuum line pressure does not decrease by some threshold amount in step 514. As discussed previously, multipicks may cause the vacuum pressure to decrease, but not by as much as a single pick. In this situation, the control system 402 may implement one or more corrective actions in step 516. For example, the control system 402 may instruct the robotic device to move the items back toward the pick location, release the items in the pick location, and perform another grasp attempt. In some embodiments, the control system 402 may issue an alert to a user. In some embodiments, the control system 402 may create an entry in a database regarding the detected multipick.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A robotic picking device comprising:
a suction device;
a vacuum device in operable connectivity with the suction device and configured to generate a suction force to enable the suction device to perform a grasp attempt.
at least one pressure sensor operably positioned with respect to the suction device and the vacuum device, and configured to detect a pressure level associated with the suction device at least during the grasp attempt; and
a control system configured to analyze the detected pressure level to determine whether the suction device grasped more than one item during the grasp attempt.

2. The robotic picking device of claim 1 wherein the control system is further configured to perform a corrective action upon determining the suction device grasped more than one item during the grasp attempt.

3. The robotic picking device of claim 2 wherein the corrective action includes at least one of issuing an alert or releasing the items.

4. The robotic picking device of claim 1 wherein the control system is further configured to:
obtain a first input pressure level from the pressure sensor before the suction device performs the grasp attempt,
compare the first input pressure level to an expected input pressure level, and
issuing an alert upon detecting that the first input pressure level deviates from the expected input pressure level beyond a threshold amount.

5. The robotic picking device of claim 1 wherein the control system determines that the suction device grasped more than one item based on the pressure level detected during the grasp attempt being above a threshold pressure level.

6. The robotic picking device of claim 1 further comprising a mass detection device configured to detect a mass of at least one item grasped by the suction device, wherein the control system further determines that the suction device grasped more than one item during the grasp attempt based at least in part on the detected mass.

7. The robotic picking device of claim 6 further comprising an arm portion operably connected to the suction device, wherein the mass detection device is configured with the arm portion.

8. The robotic picking device of claim 1 wherein the suction device is further configured to perform a second grasp attempt upon the control system determining the suction device grasped more than one item during the grasp attempt.

9. The robotic picking device of claim 1 wherein the at least one pressure sensor includes a vacuum pressure sensor positioned to measure a vacuum pressure level associated with the suction device.

10. The robotic picking device of claim 9 wherein the control system determines the suction device grasped more than one item based on a difference between a vacuum pressure level before the grasp attempt and a vacuum pressure level during the grasp attempt being above a threshold amount.

11. A method of performing a grasp attempt, the method comprising:
positioning a suction device to perform a grasp attempt;
generating, using a vacuum device in operable connectivity with the suction device, a suction force to enable the suction device to perform a grasp attempt;
detecting a pressure level associated with the suction device at least during the grasp attempt using at least one pressure sensor; and
analyzing, using a control system, the detected pressure level to determine whether the suction device grasped more than one item during the grasp attempt.

12. The method of claim 11 further comprising performing a corrective action upon the control system determining the suction device grasped more than one item.

13. The method of claim 12 wherein the corrective action includes at least one of issuing an alert or releasing the items.

14. The method of claim 11 further comprising:
obtaining a first input pressure level from the at least one pressure sensor before the suction device performs the grasp attempt,
comparing the first input pressure level to an expected input pressure level, and
issuing an alert upon detecting that the first vacuum pressure level deviates from the expected input pressure level beyond a threshold amount.

15. The method of claim 11 wherein the control system determines that the suction device grasped more than one item based on the pressure level detected during the grasp attempt being above a threshold pressure level.

16. The method of claim 11 further comprising detecting, using a mass detection device, a mass of the at least one item grasped by the suction device, wherein the control system determines that the suction device grasped more than one item during the grasp attempt based at least in part on the detected mass.

17. The method of claim 16 wherein the suction device is positioned via an arm portion operably connected to the suction device, and the mass detection device is configured with the arm portion.

18. The method of claim 11 further comprising performing a second grasp attempt upon determining the suction device grasped more than one item during the grasp attempt.

19. The method of claim 11 wherein detecting the pressure level associated with the suction device at least during the grasp attempt includes measuring a vacuum pressure level from the suction device using a vacuum pressure sensor.

20. The method of claim 19 wherein the control system determines the suction device grasped more than one item based on a difference between a vacuum pressure level before the grasp attempt and a vacuum pressure level during the grasp attempt being below a threshold amount.
